(19) United States
(12) Patent Application Publication
(10) Pub. No.: US 2025/0371406 A1
(43) Pub. Date: Dec. 4, 2025

(54) MACHINE LEARNING-BASED ERROR ANALYSIS FOR ENTERPRISE RESOURCE PLANNING APPLICATIONS

(71) Applicant: SAP SE, Walldorf (DE)

(72) Inventors: Neha GARG, Bangalore (IN); Sushil KUMAR, Bangalore (IN); Chandra Shekhar CHAUHAN, Bangalore (IN); Kumar Vidya BHUSHAN, Bangalore (IN); Ravi KOMMI, Bangalore (IN)

(21) Appl. No.: 18/677,048

(22) Filed: May 29, 2024

(51) Int. Cl. G06N 20/00

(52) U.S. Cl. CPC G06N 20/00

(57) ABSTRACT

Disclosed herein are a system, method, and computer program product embodiments for recommending knowledge resources to resolve errors at a source and/or target system. For example, a request to post data to a target system is received from a source system. A determination is made that an error occurred with respect to the request. An error context for the error is determined. The error context comprises information describing the error and information describing the system. A representation of the error context is provided as an input to an ML model. The ML model is configured to predict a knowledge resource for resolving the error based on the error context. A prediction indicating the knowledge resource for resolving the error is received from the ML model. A recommendation to apply the knowledge resource on the source and/or target system is provided via a user interface based on the prediction.

### BACKGROUND

Hundreds of knowledge resources/solutions (e.g., software patch notifications, knowledge-based articles, etc.) are generated for software product portfolios on a daily basis. These resources contain potentially valuable information for customers, helping them to fix incidents, fix bugs, prevent issues, optimize their systems, or harness new features. knowledge resources/solutions may contain program settings and/or code corrections that are used to fix errors, implement small enhancements, etc.

However, the sheer volume and variety of these resources present significant challenges. It is difficult to identify and recommend the most relevant and beneficial recommendation for a particular system. This task becomes even more complex given the diverse range of components of a given software product portfolio, which necessitates a broad spectrum of domain knowledge. An issue arises when attempting to efficiently navigate this information overload, and accurately determining the most relevant notifications.

### BRIEF DESCRIPTION OF THE DRAWINGS

The accompanying drawings are incorporated herein and form a part of the specification.

FIG. 1 is a block diagram of a system configured to recommend a knowledge resource to resolve errors at a source system and/or a target system, according to some embodiments.

FIG. 2 is a block diagram of a system configured to provide machine-learning based recommendations for knowledge resources/solutions to resolve errors at a target system, according to some embodiments.

FIG. 3 is a flowchart for a method for recommending knowledge resources/solutions to resolve errors at a source system and/or target system, according to some embodiments.

FIG. 4 is a flowchart for a method for authenticating a user, according to some embodiments.

FIG. 5 is a flowchart for a method for training a machine learning model, according to some embodiments.

FIG. 6 is a flowchart for a method for re-training a machine learning model based on sentiment reports, according to some embodiments.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

As discussed in the Background Section above, the sheer volume and variety of knowledge resources/solutions (collectively referred herein as “knowledge resources”) present significant challenges. It is difficult to identify and recommend the most relevant and beneficial knowledge resources for a specific customer system. Customers can spend weeks trying to figure out a proper resolution to the issues that they are experiencing, as they often rely on a manual search to find the right solution. Moreover, customers face the challenge that thousands of knowledge resources are technically valid for each of their systems, but may be not relevant from a business point of view or given the current context. Given the business context of a particular system, only a subset of knowledge resources may be relevant and applied. Identifying these knowledge resources will save time and compute resources and can help to avoid error situations proactively.

The embodiments described herein address the aforementioned problems via an implementation that can effectively understand the context of the issues and/or errors experienced by the user, along with the customer's system, and provide tailored recommendations that are most likely to resolve the customer's issues. Such techniques may leverage data processing and machine learning techniques to achieve this purpose, thereby automating a complex task and delivering more value to the customer base.

In particular, provided herein are system, method and/or computer program product embodiments, and/or combinations and sub-combinations thereof, for recommending knowledge resources to resolve errors at a source system and/or a target system. For example, a request to post data to a target system is received from a source system. A determination is made that an error occurred with respect to the request. An error context for the error is determined. The error context comprises information describing the error and information describing the system. A representation of the error context is provided as an input to a machine learning model. The machine learning model is configured to predict a knowledge resource for resolving the error based on the error context. A prediction indicating the knowledge resource for resolving the error is received from the machine learning model. A recommendation to apply the knowledge resource on the at least one of the source system or the target system is provided via a user interface based on the prediction.

The techniques described herein improve the functioning of a computing system. For example, because the most relevant knowledge resources are recommended to the source system and/or target system, the recommended knowledge resources are more likely to be applied in a timely fashion. By applying such knowledge resources, various issues (e.g., usability issues, performance issues, etc.) of the source system and/or target system are remedied, thereby enabling the source system and/or target system to run more efficiently and without any errors. Accordingly, various compute resources (e.g., processor cycles, memory, storage, etc.) that are normally consumed due to errors are conserved as a result of timely applying such knowledge resources.

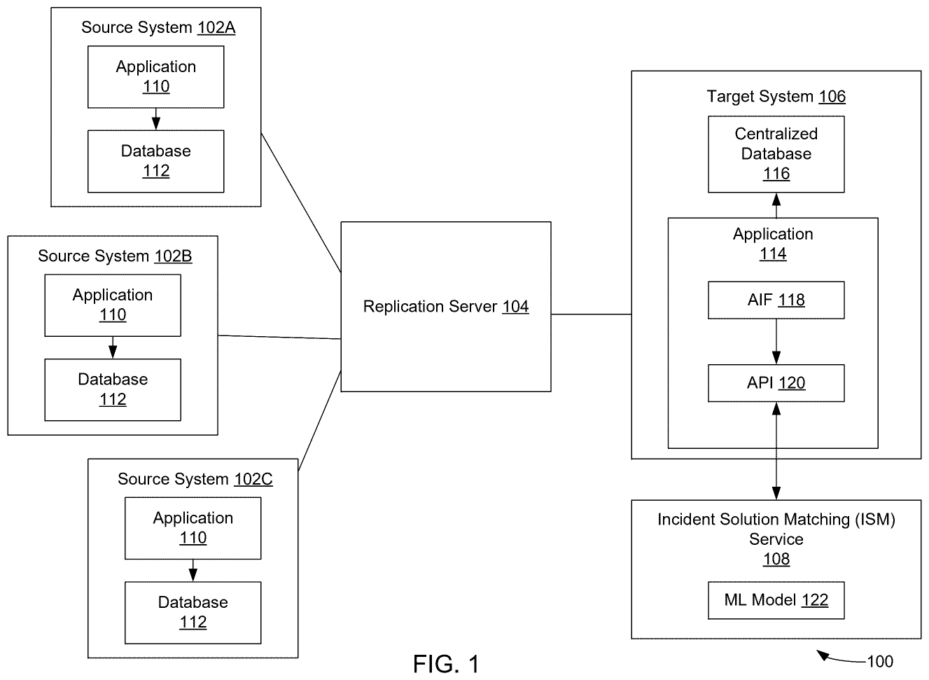

FIG. 1 shows a block diagram of a system 100 configured to recommend knowledge resources to resolve errors at a source system and/or target system, according to some embodiments. As shown in FIG. 1, system 100 includes source systems 102A, 102B, and 102C (collectively referred herein as source systems 102), a replication server 104, a target system 106, and an incident solution matching (ISM) service 108. Source systems 102, replication server 104, and target system 106, may be communicatively coupled to each other via a first network. Target system 106 and ISM service 108 may be communicatively coupled to each other via a second network. Accordingly, ISM service 108 may not be accessible by source systems 102 and replication server 104. The first and second networks may comprise one or more networks such as local area networks (LANs), wide area networks (WANs), enterprise networks, the Internet, etc., and may include one or more of wired and/or wireless portions.

Each of source systems 102 may be associated with a respective entity (e.g., a business user, a customer, etc.) of an organization, such as an enterprise or business. Each of source systems 102 may be configured to execute an application 110. Application 110 may comprise an enterprise resource planning application. Application 110 may be configured to execute core business processes for an entity associated therewith. Such processes include, but are not limited to, finance and accounting, human resource management, source and procurement, sales, manufacturing, etc. Finance and accounting processes may capture customer transactions and manage customer accounts. Such transactions include, but are not limited to, accounts receivable-related and accounts payable-related transactions (e.g., invoice posting, credit memo posting, down payments, invoice payments, etc.), closing an entity's books, generating financial reports, etc. Human resource management processes may generate attendance and payroll records. Sourcing and procurement processes may generates requests for quotes, generates contracts, etc. Sales processes may generates records pertaining to communications between the entity and customers (or potential customers), order management records, etc. Manufacturing processes may generate production scheduling records, quality management records, etc. The records (also referred herein as documents) generated by a particular source system of source systems 102 may be posted in a database 112 maintained thereby. In one example, each application 110 of source systems 102 may be configured to perform a different subset of processes, as described above. In another example, an application 110 of a first source system (e.g., source system 102A) may be a different version or may be provided by a different software vendor than an application 110 a second source system (e.g., source system 102B).

Replication server 104 may be configured to perform real-time replication of data stored in database 112 of each of source systems 102. For instance, each of source systems 102 may be configured to provide data stored in database 112 to replication server 104 in response to detecting a triggering event.

One example of a triggering event is a database triggering event. Source systems 102 may be configured to monitor modifications to database 112. Such modifications include, but are not limited to, the insertion of data in a database table of database 112, the deletion of data from a database table of database 112, a modification of data in a database table of database 112, etc. Upon detecting such modifications, source systems 102 may generate a triggering event. In response to the triggering event, source systems 102 may generate a logging table that stores the data associated with the triggering event. Once the logging tables are generated, source systems 102 may read the data from the logging tables and transfer such data to replication server 104. Replication server 104 may format the received data in a format compatible with target system 106 and provide the data to target system 106.

Target system 106 may comprise a centralized application 114 for enabling entities to replicate their documents from source systems 102 and re-post such documents in a common data format into a centralized database 116 of target system 106. This advantageously harmonizes financial data between different source systems 102 and allows financial reporting from a variety of data sources (e.g., database 112) across a business to enable much more transparency and efficiency. In an embodiment, application 114 is SAP® Central Finance that executes on SAP S/4 HANA®.

Application 114 may utilize master data management (MDM)-based techniques to harmonize data originating from different source systems 102. For instance, application 114 may query an MDM service that receives data originating from different source system 102 and formats such data in a uniform matter. In one example, the MDM service may format names listed in records so that they are specified in the same format (e.g., the first name is always followed by the last name). After records have been formatted in a unified matter, the records may be posted.

In certain scenarios, errors may occur when transferring data to target system 106 and/or posting records at target system 106. Examples of such errors include, but are not limited to, data errors, mapping errors, functional errors, and technical errors. A data error may occur, for example, when a document (e.g., a payment record) is posted for another document (e.g., an invoice record) not stored in centralized database 116. A mapping error may occur, for example, if a document stored in database 112 of source systems 102 is not properly mapped to a corresponding document stored in centralized database 116. A functional error may occur, for example, if data is not properly replicated by replication server 104 due to an improper configuration of replication server 104. A technical error may occur, for example, due to a lack of compute resources to perform the record posting. For instance, replication server 104 and/or target system 106 may be not have enough bandwidth and/or memory/storage to post the record. Replication server 104 and/or target system 106 may issue error messages indicative of such errors.

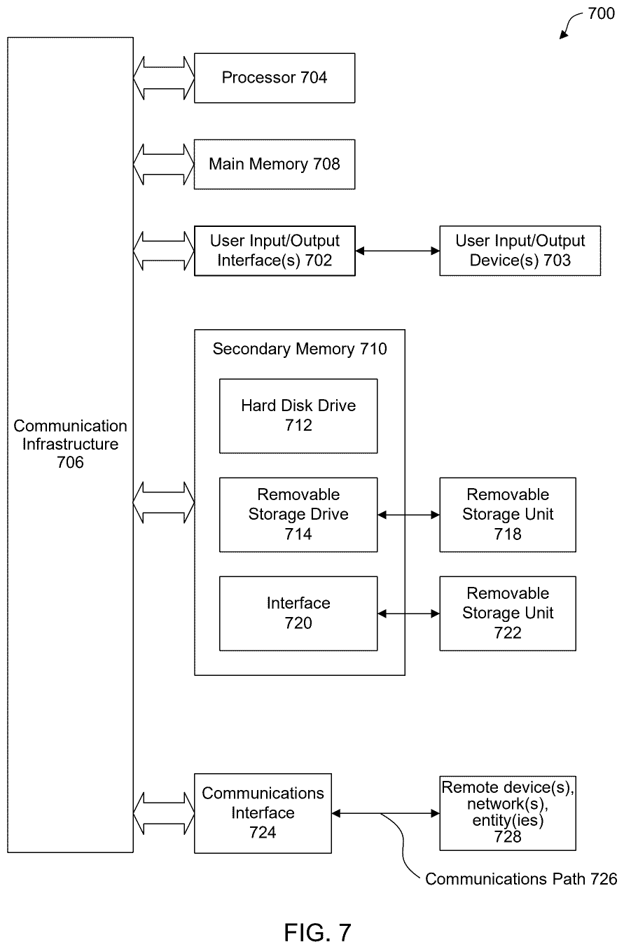

Application interface framework (AIF) 118 may be implemented by processing logic that can comprise hardware (e.g., circuitry, dedicated logic, programmable logic, microcode, etc.), software (e.g., instructions executing on a processing device), or a combination thereof. In an embodiment, AIF 118 is implemented in one or more software processes executing on one or more processor-based computer systems, such as computer system 700 as described below in reference to FIG. 7. AIF 118 may be configured to monitor replication server 104 and/or target system 106 for such error messages and determine an error context for such error messages. The error context for a given error may comprise various information describing the error. For instance, the error context may indicate the class of the error message, a message code associated with the error message, a title of the error message, a description of the error message, etc. The error context may also comprise system information describing the source system (e.g., one of source systems 102A-102C) from which the transaction that caused the error originated. Such system information may include, but is not limited to, the name and/or version of application 110, configuration settings of application 110, etc. AIF 118 may be configured to generate a request for a solution to an error. The request may include the error context. AIF 118 may provide the request to ISM service 108 via an application programming interface (API) 120, which is an interface that communicatively couples AIF 118 with ISM service 108.

In an embodiment, AIF 118 AIF 118 may provide the request to API 120, which provides the request to ISM service 108.

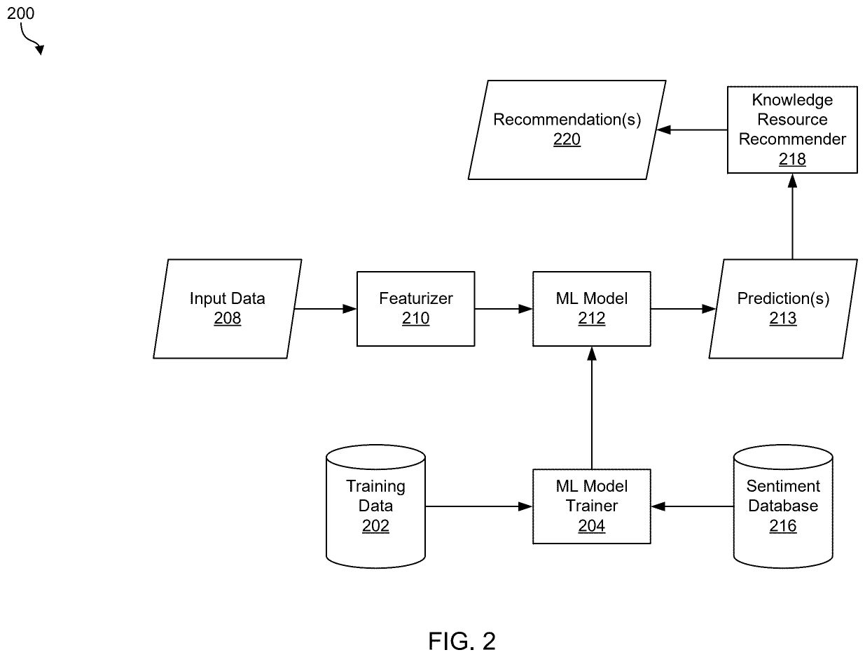

ISM service 108 may be implemented by processing logic that can comprise hardware (e.g., circuitry, dedicated logic, programmable logic, microcode, etc.), software (e.g., instructions executing on a processing device), or a combination thereof. In an embodiment, ISM service 108 is implemented in one or more software processes executing on one or more processor-based computer systems, such as computer system 700 as described below in reference to FIG. 7. ISM service 108 may be configured to recommend solutions to user(s) for source systems 102 and/or target system 106 to mitigate errors. ISM service 108 utilizes machine learning-based techniques to determine a relevant solution. For instance, ISM service 108 comprises of a machine learning (ML) model 122 that is trained to predict a solution given a particular error context. The solution may comprise a knowledge resource. Knowledge resources may provide solutions that address various software-related issues (e.g., performance issues, mapping issues, posting issues, etc.) associated with source systems 102 and/or target system 106. Examples of knowledge resources include, but are not limited to, a software patch (or update) for application 110, a notification specifying a set of instructions that, when implemented, resolve a software-related issue for application 110, etc. Examples of such patches and notifications include, but are not limited to, SAP® Notes, SAP® Security Notes, or various knowledge-based articles (KBAs). Additional details regarding ISM service 108 and ML model 122 are described below with reference to FIG. 2.

Source systems 102, replication server 104, target system 106, and ISM service 108 may be instantiated on one or more computer systems, such as computer system 700 as described below in reference to FIG. 700. Source systems 102, replication server 104, target system 106, and ISM service 108 may also be implemented on one or more servers of an enterprise network and/or a cloud computing network and accessed via a client computer system that is connected thereto, although these examples are not intended to be limiting.

In an embodiment, databases 112 and centralized database 116 are managed by and accessed via a corresponding database management system (DBMS), which is not shown in FIG. 1 for the sake of simplicity. Databases 112 and centralized database 116 and the corresponding DBMSs may be implemented on one or more computer systems, such as computer system 700 as described below in reference to FIG. 7. Databases 112 and centralized database 116 and the corresponding DBMSs may also be implemented on one or more servers of an enterprise network and/or a cloud computing network and accessed via a client computer system that is connected thereto, although these examples are not intended to be limiting.

FIG. 2 is a block diagram of a system 200 configured to provide machine-learning based recommendations for knowledge resources to resolve errors at a target system, according to some embodiments. As shown in FIG. 2, system 200 includes an ML model trainer 204, a featurizer 210, an ML model 212, and knowledge resource recommender 218. ML model 212 may be an example of ML model 122, as described above with reference to FIG. 1. In an embodiment, System 200 may implement ISM service 108. Each of these elements will now be described.

ML model trainer 204 may be implemented by processing logic that can comprise hardware (e.g., circuitry, dedicated logic, programmable logic, microcode, etc.), software (e.g., instructions executing on a processing device), or a combination thereof. In an embodiment, ML model trainer 204 is implemented in one or more software processes executing on one or more processor-based computer systems, such as computer system 700 as described below in reference to FIG. 7. ML model trainer 204 is configured to use training data 202 to train an ML algorithm. The ML algorithm generates an ML model (e.g., ML model 212) configured to predict one or more knowledge resources for mitigating errors. For instance, training data 202 may comprise a historical set of incident reports and/or error messages generated for a plurality of source systems and/or target systems. In one example, the historical set of incident reports and/or error messages include reports and/or messages generated over a predetermined time period (e.g., the last 2 years) across different source systems and/or target systems. Training data 202 may also comprise a set of knowledge resources that resolved the errors or issues indicated by the historical set. ML model trainer 204 may receive such training data 202 and input training data 202 to an ML algorithm that learns, based on training data 202, which types of knowledge resources were utilized to mitigate the types of errors indicated by the historical set. The trained ML algorithm is represented as ML model 212.

Featurizer 210 may be implemented by processing logic that can comprise hardware (e.g., circuitry, dedicated logic, programmable logic, microcode, etc.), software (e.g., instructions executing on a processing device), or a combination thereof. In an embodiment, featurizer 210 is implemented in one or more software processes executing on one or more processor-based computer systems, such as computer system 700 as described below in reference to FIG. 7. Featurizer 210 may be configured to receive input data 208. Input data 208 may correspond to the error context of an error message detected by AIF 118. Featurizer 210 may be configured to generate a representation (e.g., a feature vector) of input data 208. Representations generated by featurizer 210 may take any form, such as a numerical,, and/or textual representation, or may comprise any other suitable form. Featurizer 210 may operate in a number of ways to featurize input data 208. For example and without limitation, featurizer 210 may featurize input data 208 through, keyword featurization, semantic-based featurization, n-gram-term frequency-inverse document frequency (TF-IDF) featurization, and/or document-to-vector (doc2vec)-based featurization. The representations generated for input data 208 are provided to ML model 206. It is noted that training data 202 may also be provided to featurizer 210, which generates representations of training data 202. Such representations may be provided as an input to ML model trainer 204.

In an embodiment, ML model 212 comprises an unsupervised ML model. In accordance with such an embodiment, ML model 212 may comprise any of clustering-based, neural network-based, or dimensionality reduction-based unsupervised ML models. However, these examples are not intended to be limiting and ML model 212 may comprise a variety of other ML model types.

Once ML model 212 has been trained by ML model trainer 204, ML model 212 can then be used to predict a particular knowledge resource to mitigate the error specified by input data 208. For example, ML model 212 may analyze the representation of input data 208 and outputs one or more predictions 213 as to which knowledge resource(s) should be applied to the source system and/or target system from which input data 208 originated. In an embodiment, ML model 212 also outputs a probability associated with each of prediction(s) 213. Such a probability may represent a degree of confidence associated with the corresponding prediction.

Knowledge resource recommender 218 may be implemented by processing logic that can comprise hardware (e.g., circuitry, dedicated logic, programmable logic, microcode, etc.), software (e.g., instructions executing on a processing device), or a combination thereof. In an embodiment, knowledge resource recommender 218 is implemented in one or more software processes executing on one or more processor-based computer systems, such as computer system 700 as described below in reference to FIG. 7. Knowledge resource recommender 218 may provide one or more recommendations 220 to apply predicted knowledge resource(s) to application 114 via API 120. Application 114 may provide an interface via which a user may view recommendation(s) 220 via application 110. In an embodiment, knowledge resource recommender 218 is configured to determine whether prediction(s) 213 meet a particular threshold. The predicted knowledge resource(s) having a prediction probability that meets the particular threshold may be provided as recommendation(s) 220. Recommendations(s) 220 may be presented on a user interface associated with application 114 and/or application 110. In an example, recommendation(s) 220 may comprise a resource identifier (e.g., a link) that, when selected by the user, enables the user to view recommended knowledge resource(s) (e.g., via a web page corresponding to a link) and/or download the knowledge resource(s) for viewing and/or installation.

In an embodiment, ML model trainer 204 may be configured to re-train ML model 212 based on the sentiment of the customer that applies a recommended knowledge resource. For instance, ML model trainer 204 may be communicatively coupled to a sentiment database 216. Sentiment database 216 is intended to represent one or more databases that store various sentiment reports that indicate whether a user was satisfied with a knowledge resource recommended to solve an issue. In an example, the sentiment reports may indicate feedback provided by a user (e.g., via a user interface) that indicates whether the application of a predicted knowledge resource was successful or unsuccessful. In another example, the sentiment reports may include a textual representation of a communication between the user and a support engineer that indicates whether the application of a predicted knowledge resource was successful or unsuccessful. Using the sentiment reports, ML model trainer 204 may weight knowledge resources to which the sentiment reports relate accordingly. For instance, if a sentiment report indicates that a particular knowledge resource was not effective in solving an issue, the knowledge resource may be weighted negatively so that such a knowledge resource is less likely to be recommended in the future for that particular issue. If a sentiment report indicates that a particular knowledge resource was effective in solving an issue, the knowledge resource may be weighted positively so that such a knowledge resource is more likely to be recommended in the future for that particular issue.

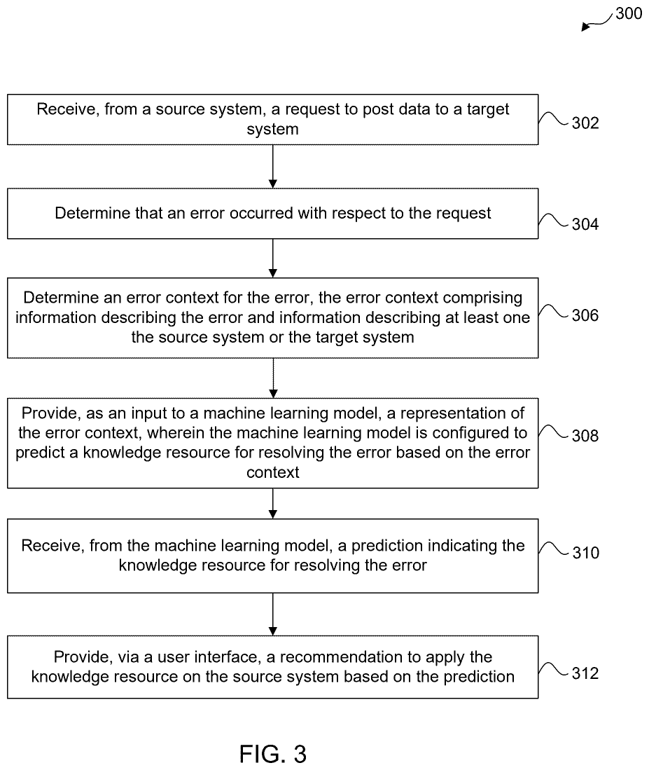

FIG. 3 is a flowchart for a method 300 for recommending knowledge resources to resolve errors at a target system, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIGS. 1 and 2. However, method 300 is not limited to that example embodiment.

In 302, application 114 of target system 106 may receive, from a source system (e.g., one of source systems 102), a request to post data to target system 106. In an embodiment, as described herein, the data comprises a document pertaining to a financial transaction initiated at the source system.

In 304, AIF 118 may determine that an error occurred with respect to the request.

In 306, AIF 118 may determine an error context for the error, the error context comprising information describing the error and information describing at least one of the source system (e.g., one of source systems 102) or target system 106

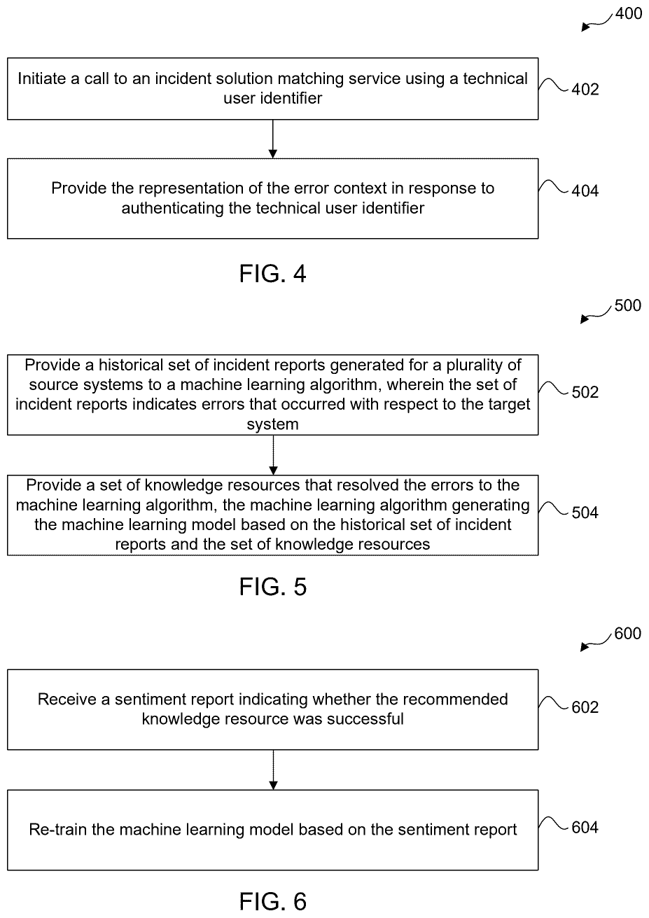

In 308, ISM service 108 may provide, as an input to ML model 122, a representation of the error context, wherein ML model 122 is configured to predict a knowledge resource for resolving the error based on the error context. For instance, API 120 of application 114 may provide a request comprising the error context to ISM service 108. ISM service 108 may obtain the error context from the request and provide the error context to featurizer 210 as input data 208. Featurizer 210 may generate a representation of the error context and provide the representation as an input to ML model 212. In an embodiment, the representation of the error context is provided based on an authentication of a user of the source system. In an embodiment, ML model 212 is an unsupervised machine learning model. Additional details regarding authentication of the user is described below with reference to FIG. 4. Additional details regarding training ML model 212 are described below with reference to FIG. 5.

In 310, knowledge resource recommender 218 may receive prediction 213 indicating the knowledge resource for resolving the error.

In 312, application 114 may provide, to a user interface (e.g., of at least one of source systems 102 or target system 106), recommendation 220 to apply the knowledge resource (e.g., a relevant knowledge resource tailored to the error context) on at least one of the source system (e.g., one of source systems 102) or target system 106. For instance, ML model 212 may output prediction(s) 213 as to which knowledge resource should be applied to the at least one of source system(s) 102 or target system 106 from which input data 208 originated. Knowledge resource recommender 218 may analyze prediction(s) 213 and determine recommendation(s) 220 for knowledge resource(s) based on prediction(s) 213. The determined recommendation(s) 220 may be provided to application 114 via API 120.

Application 114 may provide an interface via which a user may view recommendation(s) 220 via application 110.

In an embodiment, the recommended knowledge resource(s) (e.g., recommendation(s) 220) comprise at least one of a set of instructions for rectifying the error at the source system (e.g., one of source systems 102) and/or target system 106, a software patch to be applied at the source system 102 and/or target system 106, or knowledge base articles comprising solutions for rectifying the error at the source system 102 and/or target system 106.

FIG. 4 is a flowchart for a method 400 for authenticating a user, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIG. 2. However, method 400 is not limited to that example embodiment.

In 402, AIF 118 may initiate a call to ISM service 108 using a technical user identifier. The technical user identifier may identify a technical user that is enabled to run tasks on source systems 102 and/or target system 106 for various activities and automated processes. Such activities include, but are not limited to customer-specific tasks, such as running and scheduling jobs.

In 404, AIF 118 may provide the representation of the error context in response to authenticating the technical user identifier.

FIG. 5 is a flowchart for a method 500 for training an ML model, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIG. 2. However, method 500 is not limited to that example embodiment.

In 502, ML model trainer 204 may provide a historical set of incident reports generated for a plurality of source systems (e.g., including source systems 102) to a machine learning algorithm, wherein the set of incident reports indicates errors that occurred with respect to target system 106. Incident reports may be included as part of training data 202.

In 504, ML model trainer 204 may provide a set of knowledge resources that resolved the errors to the machine learning algorithm, the machine learning algorithm generating ML model 212 based on the historical set of incident reports and the set of knowledge resources. The set of knowledge resources may be included as part of training data 202.

FIG. 6 is a flowchart for a method 600 for re-training an ML model based on sentiment reports, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIG. 2. However, method 600 is not limited to that example embodiment.

In 602, ML model trainer 204 may receive a sentiment report (e.g., from sentiment database 216) indicating whether the recommended knowledge resource was successful.

In 604, ML model trainer 204 may re-train ML model 212 based on the sentiment report.

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving, from a source system, a request to post data to a target system;
determining that an error occurred with respect to the request;
determining an error context for the error, the error context comprising information describing the error and information describing the source system;
providing, as an input to a machine learning model, a representation of the error context, wherein the machine learning model is configured to predict a knowledge resource for resolving the error based on the error context;
receiving, from the machine learning model, a prediction indicating the knowledge resource for resolving the error; and
providing, via a user interface, a recommendation to apply the knowledge resource on the at least one of the source system or the target system based on the prediction.

2. The computer-implemented method of claim 1, wherein providing the representation of the error context comprises:
initiating a call to an incident solution matching service using a technical user identifier; and
providing the representation of the error context in response to authenticating the technical user identifier.

3. The computer-implemented method of claim 1, wherein the machine learning model is trained by:
providing a historical set of incident reports generated for a plurality of source systems to a machine learning algorithm, wherein the historical set of incident reports indicates errors that occurred with respect to the target system; and
providing a set of knowledge resources that resolved the errors to the machine learning algorithm, the machine learning algorithm generating the machine learning model based on the historical set of incident reports and the set of knowledge resources.

4. The computer-implemented method of claim 1, further comprising:
receiving a sentiment report indicating whether the recommended knowledge resource was successful; and
re-training the machine learning model based on the sentiment report.

5. The computer-implemented method of claim 1, wherein the recommended knowledge resource comprises at least one of:
a set of instructions for rectifying the error at one or more of the source system or the target system;
a software patch to be applied at one or more of the source system or the target system; or
knowledge base articles comprising solutions for rectifying the error at one or more of the source system or the target system.

6. The computer-implemented method of claim 1, wherein the data comprises a document pertaining to a financial transaction initiated at the source system.

7. The computer-implemented method of claim 1, wherein the machine learning model is an unsupervised machine learning model.

8. A system, comprising:
a memory; and
at least one processor coupled to the memory and configured to:
receive, from a source system, a request to post data to a target system;
determine that an error occurred with respect to the request;
determine an error context for the error, the error context comprising information describing the error and information describing the source system;
provide, as an input to a machine learning model, a representation of the error context, wherein the machine learning model is configured to predict a knowledge resource for resolving the error based on the error context;
receive, from the machine learning model, a prediction indicating the knowledge resource for resolving the error; and
provide, via a user interface, a recommendation to apply the knowledge resource on the at least one of the source system or the target system based on the prediction.

9. The system of claim 8, wherein, to provide the representation of the error context, the at least one processor is configured to:
initiate a call to an incident solution matching service using a technical user identifier; and
provide the representation of the error context in response to authenticating the technical user identifier.

10. The system of claim 8, wherein, to train the machine learning model, the at least one processor is configured to:
provide a historical set of incident reports generated for a plurality of source systems to a machine learning algorithm, wherein the historical set of incident reports indicates errors that occurred with respect to the target system; and
provide a set of knowledge resources that resolved the errors to the machine learning algorithm, the machine learning algorithm configured to generate the machine learning model based on the historical set of incident reports and the set of knowledge resources.

11. The system of claim 8, wherein the at least one processor is configured to:
receive a sentiment report indicating whether the recommended knowledge resource was successful; and
re-train the machine learning model based on the sentiment report.

12. The system of claim 8, wherein the recommended knowledge resource comprises at least one of:
a set of instructions for rectifying the error at one or more of the source system or the target system;
a software patch to be applied at one or more of the source system or the target system; or
knowledge base articles comprising solutions for rectifying the error at one or more of the source system or the target system.

13. The system of claim 8, wherein the data comprises a document pertaining to a financial transaction initiated at the source system.

14. The system of claim 8, wherein the machine learning model is an unsupervised machine learning model.

15. A non-transitory computer-readable device having instructions stored thereon that, when executed by at least one computing device, causes the at least one computing device to perform operations, the operations comprising:
receiving, from a source system, a request to post data to a target system;
determining that an error occurred with respect to the request;
determining an error context for the error, the error context comprising information describing the error and information describing the source system;
providing, as an input to a machine learning model, a representation of the error context, wherein the machine learning model is configured to predict a knowledge resource for resolving the error based on the error context;
receiving, from the machine learning model, a prediction indicating the knowledge resource for resolving the error; and
providing, via a user interface, a recommendation to apply the knowledge resource on the at least one of the source system or the target system based on the prediction.

16. The non-transitory computer-readable device of claim 15, wherein providing the representation of the error context comprises:
initiating a call to an incident solution matching service using a technical user identifier; and
providing the representation of the error context in response to authenticating the technical user identifier.

17. The non-transitory computer-readable device of claim 15, wherein the machine learning model is trained by:
providing a historical set of incident reports generated for a plurality of source systems to a machine learning algorithm, wherein the historical set of incident reports indicates errors that occurred with respect to the target system; and
providing a set of knowledge resources that resolved the errors to the machine learning algorithm, the machine learning algorithm generating the machine learning model based on the historical set of incident reports and the set of knowledge resources.

18. The non-transitory computer-readable device of claim 15, the operations further comprising:
receiving a sentiment report indicating whether the recommended knowledge resource was successful; and
re-training the machine learning model based on the sentiment report.

19. The non-transitory computer-readable device of claim 15, wherein the recommended knowledge resource comprises at least one of:
a set of instructions for rectifying the error at one or more of the source system or the target system;
a software patch to be applied at one or more of the source system or the target system; or
knowledge base articles comprising solutions for rectifying the error at one or more of the source system or the target system.

20. The non-transitory computer-readable device of claim 15, wherein the data comprises a document pertaining to a financial transaction initiated at the source system.
